(19) United States
(12) Patent Application Publication
(10) Pub. No.: US 2021/0016508 A1
(43) Pub. Date: Jan. 21, 2021

(54) Powder Fluidization for Use in Additive Manufacturing for Object Removal and Removal of Powder from Object

(71) Applicant: Southwest Research Institute, San Antonio, TX (US)

(72) Inventors: Albert Joseph Parvin, Jr., San Antonio, TX (US); Cliff James Scribner, San Antonio, TX (US); Grahm Collins Roach, San Antonio, TX (US)

(21) Appl. No.: 16/517,130

(22) Filed: Jul. 19, 2019

(51) Int. Cl. B29C 64/35; B29C 64/153; B29C 64/255; B29C 64/245

(52) U.S. Cl. CPC B29C 64/35; B29C 64/153; B33Y 10/00; B29C 64/245; B29C 64/255

(57) ABSTRACT

A removal method for an object of manufacture after a powder-based additive manufacturing process. The object is made in a build box, in which powder is fused using a powder-based additive manufacturing process. A fluid is delivered into the build box, the fluid having a pressure and composition suitable for fluidizing powder not used for manufacture of the object. This results in fluidization of the powder in the build box, from which the object may easily be extracted.

### TECHNICAL FIELD OF THE INVENTION

This invention relates to additive manufacturing, and more particularly to using powder fluidization for removal of a manufactured object from a build box and for removal of powder from the object.

### BACKGROUND OF THE INVENTION

Powder-based additive manufacturing is referred to as such because the additive manufacturing process uses powder as the medium for building the object of manufacture. Power-based additive manufacturing is also referred to as “powder bed fusion”.

Powder-based additive manufacturing can be used with various powdered materials and its flexibility allows for geometrically complex three-dimensional structures. As with other additive manufacturing processes, the object is first modeled with data, and then computerized equipment then builds the object layer-by-layer. In a powder-based process, the layers are formed by sintering or otherwise fusing powder granules.

Examples of powder-based additive manufacturing are selective laser sintering, with both metals and polymers, and direct metal laser sintering. Selective laser melting does not use sintering for the fusion of powder but rather melts a powder using a high-energy laser. Electron beam melting is another example and manufactures parts by melting metal powder layer by layer with an electron beam.

A characteristic of powder-based additive manufacturing is that that the object is made inside a “build box” containing the powder. The object must be removed from the build box once it is formed and the powder must be removed from the object. Conventionally, this removal process involves removing the build box from the additive manufacturing system, removing the object, then manually separating the powder from the object. Problems with conventional removal processes include but are not limited to wasted powder material, damage to delicate parts, extensive labor expenses, and safety hazards from exposure to loose powder.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a build box assembly having a moveable platform with a manufactured object resting in fluidized powder.

FIG. 2 illustrates the build box assembly of FIG. 1, but with the platform raised and fluidized powder having spilled out from the build box.

FIG. 3 illustrates a platform having a network of fluid delivery lines and holes for allowing fluidized powder to flow through the platform.

FIG. 4 illustrates an embodiment of the build box assembly in which the fluid is delivered via the walls of the build box.

FIG. 5 illustrates a build box assembly having a non-moving platform but in which the fluidized powder has a density that provides buoyancy to the object.

FIG. 6 illustrates a removal process for an object made by powder-based additive manufacturing.

### DETAILED DESCRIPTION OF THE INVENTION

The following description is directed to a removal process suitable for powder-based additive manufacturing. As described in the Background, additive manufacturing builds three-dimensional objects. Once a computer model is designed, the additive manufacturing equipment reads in data and fuses powder to fabricate the object. The fusing process is sometimes referred to as “sintering” although other terminology may be appropriate depending on the particular type of power-based process being used.

Fluidization Build Box with Movable Platform

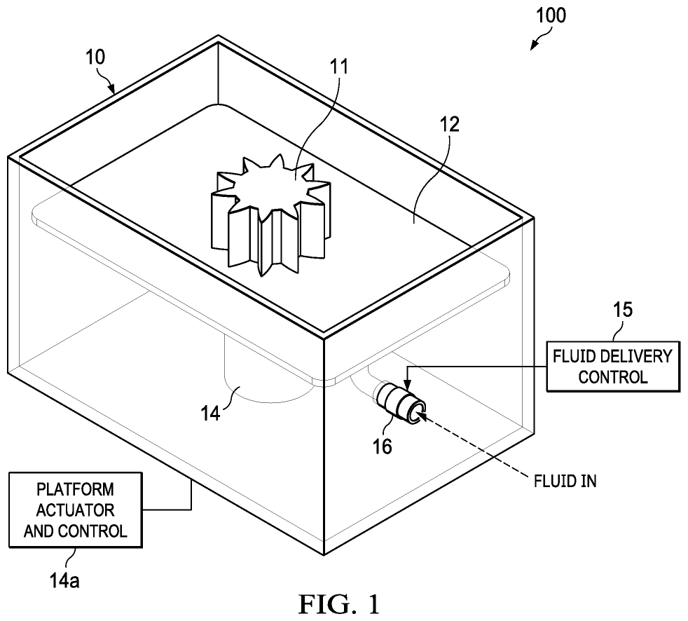

FIG. 1 is a perspective view illustrating a fluidization build box system 100 in accordance with the invention. An object of manufacture 11 has been manufactured by fusing powder within a build box 10. To make object 11, a laser, electron beam, thermal printhead or other equipment, guided by digital data, has selectively melted the powder, which fuses to the preceding layer. The exact technique of applying layers is not important to the invention - various types of sintering or other powder-fusing methods may be used.

As further explained in detail below, after a portion of the powder is sintered or otherwise fused to make object 11, the powder not used to manufacture object 11 is fluidized within the build box 10. This facilitates removal of the object 11 from the build box 10 and removal of unfused powder from the object 11.

A platform 12 is moveable vertically within the build box 10. In the embodiment of FIG. 1, the manufactured object 11 is complete and is resting on platform 12 submerged within fluidized powder that is also above platform 12.

The junction between platform 12 and the inner walls of build box 10 need not be sealed. As described below, in some embodiments, some or all of the fluidized powder flows around or through the platform 12 into the portion of build box 10 below platform 12.

The mechanics for moving platform 12 are not explicitly shown, but various actuation means may be used for moving platform 12 up and down within build box 10. In the embodiment of FIG. 1, platform 12 rests on a central pier 14, which pushes platform 12 up or down. In other embodiments, platform 12 may be pulled or pushed up and down with other elevating mechanisms. For example, platform 12 could be pulled up in a manner similar to an elevator. Or, platform 12 could ride on tracks on the sides of build box 10. Leveler or scissor lift equipment could be used, as well as screw/gear mechanisms, or rack and gear or rack and pinion mechanisms. The platform 12 could be pulled or pushed from above the build box 10 rather than from below.

A platform actuator/controller 14a controls the timing and extent of movement of platform 12. It is assumed that actuator/controller 14a has appropriate hardware and/or software for performing the tasks described herein.

As indicated, a fluid (gas or liquid) is introduced into build box 10 for the purpose of fluidization of unfused powder within build box 10. The type of fluid used for fluidization may vary with different types of powders and desired density of fluidization.

A fluid delivery network (such as is shown in FIG. 3) delivers the fluid into build box 10. Various configurations for the fluid delivery network are described below.

A fluid delivery controller 15 controls the timing and volume of fluid to be delivered into the build box 10. It is assumed that controller 15 has appropriate hardware and/or software for performing the tasks described herein. A valve 16 may be used to control fluid flow into box 10.

As a result of fluid delivered into build box 10, the unfused powder within build box 10 becomes a fluidized bed of material that behaves like a liquid. This fluidization is caused by the suspension of unfused powder particles. The suspension of the powder particles is caused when the force of fluid introduced into the powder is equal to the powder particles' weight (i.e., buoyancy). The fluid introduction causes particles of a certain density to rise or fall in relation to the buoyancy force, suspending in a state where equilibrium is achieved.

The fluidization of unused powder allows object 11 to be removed easily from build box 10. The removal process is analogous to pulling an object out of a tub of liquid. Alternatively, platform 12 could be raised such that the fluidized powder is displaced out of the top of the build box 10.

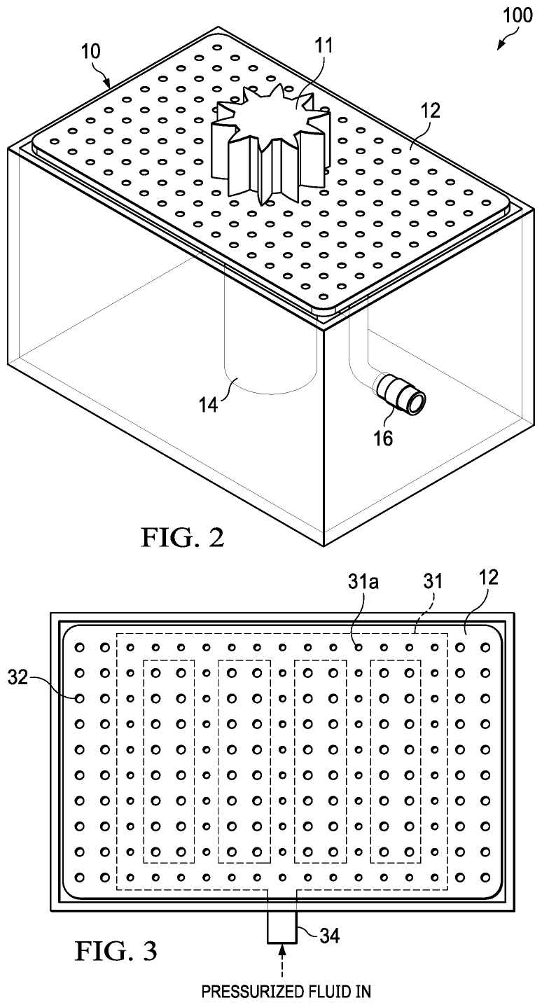

FIG. 2 illustrates an embodiment of the invention in which platform 12 is configured like a sieve, which allows fluidized powder to flow through platform 12 into the bottom portion (below platform 12) of build box 10. Platform 12 has numerous small holes of appropriate size for allowing fluid to flow through it. In this configuration, platform 12 may be raised to lift object 11 out of the fluidized powder. The fluidized powder, now displaced to be under platform 12, may then be removed so that platform 12 can be lowered again.

FIG. 3 is a plan view of the platform 12 of FIG. 2, showing a fluid delivery network 31 on or in platform 12, used to deliver fluid into the build box 10. FIG. 3 further illustrates holes 32 used to make platform “sieve-like” as described above in connection with FIG. 2.

Fluid delivery network 31 may be a configuration of pipes or tubes having ports 31a, which allow liquid to enter into the build box 10 for fluidization of powder within build box 10. As indicated, a main delivery line 34 delivers the fluid, which is typically pressurized. The location of ports 31a may vary. For example, ports 31a may be on the upper sides of the pipes (in the direction of the powder above the fluid delivery network) or on their lower sides, or on both sides.

The “fluid delivery network” may have alternative configurations other than pipes or tubes. For example, the fluid delivery network could be a perforated plate, with fluid delivered via the perforations.

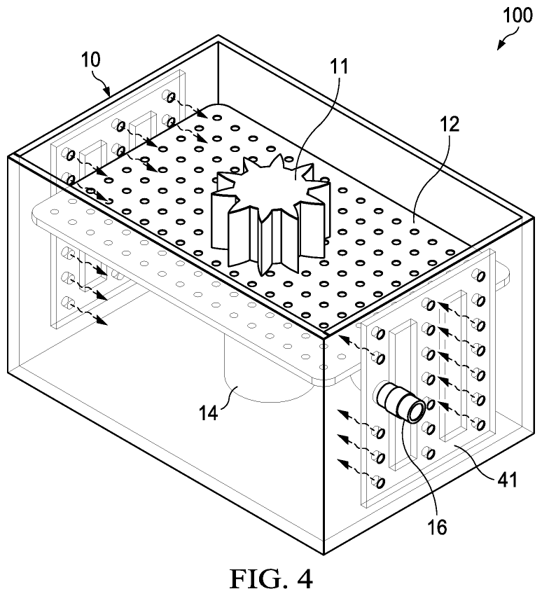

FIG. 4 is an alternative embodiment in which the fluid is delivered into build box 10 using a fluid delivery network 41 in or on the inner walls of build box. In the embodiment of FIG. 4 two side walls deliver fluid, but the fluid delivery network 41 could be in or on any of the inner walls including the bottom surface. The fluid delivery network 41 and its ports 41a deliver fluid into build box 10 in addition to or instead of using delivery lines in or on platform 12.

In the embodiment of FIG. 4, the fluid delivery network 41 may be configured to deliver fluid above platform 12 or below or both. If the fluid is introduced below platform 12, as the platform 12 rises the fluidized powder may flow around or through the platform. In this case, the platform can be re-lowered through the fluidized powder.

Regardless of the configuration of the fluid delivery network 31 or 41, agitation or vibration within build box 10 may be used to enhance fluidization. Properly implemented, the agitation or vibration introduces micro air paths within the powder.

Fluidization Build Box with Stationary Platform

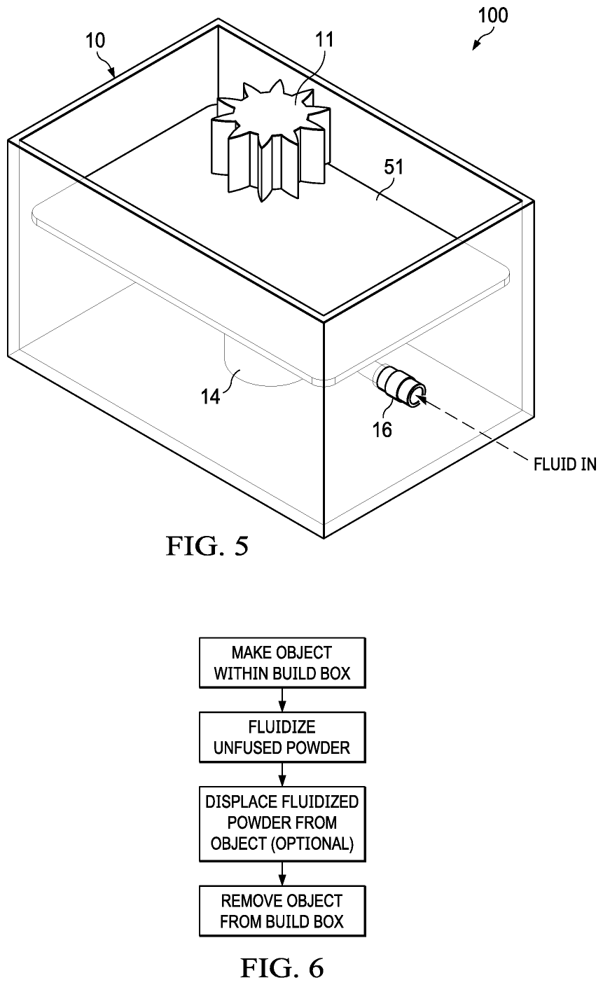

FIG. 5 illustrates a further alternative embodiment of the invention, in which platform 51 does not move vertically within build box 10. In other words, platform 51 is a stationary platform. However, as in FIG. 3, platform 51 may have a fluid delivery network for delivering a fluid and thereby fluidizing unfused powder. Alternatively, or in addition, as in FIG. 4, the fluid delivery network may be placed in or on the walls or bottom of build box 10.

In the embodiment of FIG. 5, although platform 51 does not move, the fluidization process is similar to that described above. Both removal of object 11 from the powder and removal of powder from object 11 are facilitated. The fluidization may be controlled such that object 11 sinks, floats or rises as desired. Platform 51 may be sieve-like or otherwise allow the fluidized powder to be displaced out of the build box or below the platform.

A feature of all embodiments is that the fluidization may be controlled to produce a desired “buoyancy” of the object 11. As shown in FIG. 5, the fluidization may allow object 11 to float above platform 51 within the build box 10. In general, the density of the fluid can be controlled to produce a desired buoyancy. There may be different manufacturing scenarios in which it is desired for an object to sink, rise, or be neutrally buoyant.

Fluidizing Build Box Methods

FIG. 6 illustrates a method of using build box system, such as system 100, for part removal after an object is manufactured using powder-based additive manufacturing. In Step 61, the object is manufactured in a build box. In Step 63, the unused powder within the build box is fluidized. Step 65 is optional, and is removing the fluidized powder from the object. Any of the fluid displacement embodiments described above may be used with or without a vertically translating platform. As explained above, if Step 65 is not performed, Step 67 (removing the object from the build box) may be easily lifted from out of the fluidized powder.

Another use of the fluidization build box (all embodiments) is for introduction of an already manufactured or partially manufactured part for “re-manufacturing”, i.e., for repair or further manufacture. The build box 10 is first filled with a fluidized powder. The object is lowered into build box 10. The fluidization is turned off, and the powder becomes “un-fluidized”. The object is now captured within the previously fluidized powder. At this point, the re-manufacturing proceeds, using the powder-base additive manufacturing process described above.

A further use of the fluidization build box system (all embodiments) is to level the powder or a platform within the build box. To level a platform, powder is fluidized below the platform. The platform will then float atop the fluidized powder and will seek a level position. Similarly, powder within the build box may be fluidized and leveled above the build box. Agitation and/or vibration may be used to assist in the leveling process.

What is claimed is:

1. A build box assembly for use during a powder-based additive manufacturing process of an object of manufacture, comprising:
a build box for containing the object and powder used to make the object;
a platform within the build box, located under the powder and under the object;
a fluid delivery network for delivering fluid into the build box;
wherein upon delivery of the fluid into the build box, all or a portion of powder not used to make the object becomes fluidized.

2. The build box assembly of claim 1, wherein the fluid delivery network is on or in the platform and provides entry of the fluid via the platform.

3. The build box assembly of claim 1, wherein the fluid delivery network is in or on the walls or bottom of the build box and provides entry of the fluid via the build box.

4. The build box assembly of claim 1, wherein the platform has openings for allowing fluidized powder to sieve through the platform.

5. The build box assembly of claim 1, wherein the platform is vertically moveable within the build box.

6. The build box assembly of claim 1, wherein the fluid delivery network is one or more tubes with ports for emitting fluid.

7. The build box assembly of claim 1, wherein the fluid delivery network comprises a perforated plate.

8. A removal method for an object of manufacture after a powder-based additive manufacturing process, comprising:
using the powder-based additive manufacturing process to manufacture the object by fusing powder within a build box;
delivering a fluid into the build box;
wherein the fluid has a pressure and composition suitable for fluidizing powder not used for manufacture of the object, thereby resulting in fluidized powder within the build box; and
removing the object from the build box.

9. The removal method of claim 8, wherein the build box has a platform beneath the object.

10. The removal method of claim 9, wherein the platform has holes for allowing fluidized powder to flow from above the platform to below the platform.

11. The removal method of claim 9, wherein the platform is vertically moveable within the build box.

12. The removal method of claim 11, further comprising moving the platform upwardly to raise the object out from the fluidized powder, prior to the removing step.

13. The removal method of claim 8, wherein the step of delivering fluid into the build box is performed with a network of fluid delivery tubes in or on the platform.

14. The removal method of claim 8, wherein the step of delivering fluid into the build box is performed with a network of fluid delivery tubes in or on the build box.

15. The removal method of claim 8, wherein the fluid is delivered such that the object is buoyant within the build box.

16. The removal method of claim 8, wherein the fluid is delivered such that the object sinks within the build box.

17. The removal method of claim 8, wherein the fluid is delivered such that the object sinks within the build box.

18. The removal method of claim 8, further comprising displacing the fluidized powder out of the build box prior to removing the object.

19. A method of re-manufacturing an object of manufacture, comprising:
providing a build box containing powder for use in a powder-based additive manufacturing process to be applied to the object of manufacture;
delivering a fluid into the build box;
wherein the fluid has a pressure and composition suitable for fluidizing powder not used for manufacture of the object, thereby resulting in fluidized powder within the build box;
placing the object into the fluidized powder;
ceasing the delivery of fluid into the build box, such that the fluidized powder becomes un-fluidized; and
performing the powder-based manufacturing process to fuse powder to the object, thereby further manufacturing the object.

20. A method of leveling powder before or during powder-based additive manufacturing, comprising:
providing a build box containing powder for use in a powder-based additive manufacturing process to be applied to the object of manufacture;
delivering a fluid into the build box;
wherein the fluid has a pressure and composition suitable for fluidizing powder not used for manufacture of the object, thereby resulting in fluidized powder within the build box.
